(19) United States
(12) Patent Application Publication
(10) Pub. No.: US 2010/0024306 A1
(43) Pub. Date: Feb. 4, 2010

(54) CROSS ARM MODULE FOR VEHICLE DOOR

(76) Inventor: Brian H. Staser, Oxford, MI (US)

Correspondence Address: CANTOR COLBURN, LLP, 20 Church Street, 22nd Floor, Hartford, CT, 06103, US

(21) Appl. No.: 12/533,456

(22) Filed: Jul. 31, 2009

Related U.S. Application Data
(60) Provisional application No. 61/085,378, filed on Jul. 31, 2008.

(51) Int. Cl. E05F 15/16; B60J 5/04; E06B 7/16; E06B 3/00

(52) U.S. Cl. 49/349; 49/502; 49/475.1; 49/506

(57) ABSTRACT

A cross arm module for a vehicle door is provided, the cross arm module having a plastic carrier plate configured to have a periphery to completely cover a periphery of an opening in an inner panel of the vehicle door, the plastic carrier plate having an inner surface and an outer surface; a window lift system mounted to the outer surface, the window lift system having a pair of cross arms each being pivotally secured to each other and movably secured to the outer surface for movement between a first position, wherein the window lift system is capable of being positioned such that no components of the window lift system extend past the periphery of the carrier plate and a second position wherein the window lift system is capable of extending past the periphery of the carrier plate; and a sealing member disposed about the periphery of the carrier plate, the sealing member providing a moisture barrier between the carrier plate and the opening in the inner panel.

### CROSS REFERENCE TO RELATED APPLICATIONS

The present application claims the benefit of U.S. Provisional Patent Application, Ser. No. 61/085,378 filed Jul. 31, 2008, the contents of which are incorporated herein by reference thereto.

### BACKGROUND

Exemplary embodiments of the present invention relate to assemblies for vehicle doors and more particularly to a door module for a vehicle door.

It is customary in the design and manufacture of vehicles to incorporate many parts into subassemblies to increase manufacturability. These subassemblies, commonly called modules, include a number of interrelated parts that can be assembled quickly and easily and then subsequently incorporated into the final assembly of a vehicle.

One such module is a module mounted to a vehicle door. Door modules can include wiring harnesses, an inside handle and latch system, a window lift system as well as other components. The module is typically loaded into a doorframe from the inboard side wherein certain components such as the window lift mechanism must be loaded into an opening the module is covering.

Moisture barriers are required to ensure that the interior passenger side of the door is kept dry by providing a seal about the opening the door module is being inserted onto.

It is therefore desirable to provide a door module that is lower in production costs while maintaining the functional strength and performance of the panel and increased ease of manufacturability and installation.

### SUMMARY OF THE INVENTION

In accordance with an exemplary embodiment of the invention, a cross arm module for a vehicle door is provided, the cross arm module having a plastic carrier plate configured to have a periphery to completely cover a periphery of an opening in an inner panel of the vehicle door, the plastic carrier plate having an inner surface and an outer surface; a window lift system mounted to the outer surface, the window lift system having a pair of cross arms each being pivotally secured to each other and movably secured to the outer surface for movement between a first position, wherein the window lift system is capable of being positioned such that no components of the window lift system extend past the periphery of the carrier plate and a second position wherein the window lift system is capable of extending past the periphery of the carrier plate; and a sealing member disposed about the periphery of the carrier plate, the sealing member providing a moisture barrier between the carrier plate and the opening in the inner panel.

In accordance with another exemplary embodiment of the present invention, a method for securing a cross arm module to a vehicle door is also provided, the method including the steps of moving a window lift system of the cross arm module to a stowed position such that no components of the window lift system extend past a periphery of a plastic carrier plate of the cross arm module; securing the plastic carrier plate to an opening in a vehicle door panel, the plastic carrier plate being configured to have a periphery to cover a periphery of the opening in the vehicle door, the plastic carrier plate having an inner surface and an outer surface; and extending the window lift system of the cross arm module to a full down position after the plastic carrier has been secured to the opening in the vehicle door such that components of the window lift system extend past the periphery of the plastic carrier plate of the cross arm module.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIGS. 1 and 2 are side elevational views of an exemplary embodiment is a full down position;

FIGS. 3 and 4 are side elevational views of an exemplary embodiment in a stowed position;

FIG. 5A is a side view illustrating a cross arm module of an exemplary embodiment of the present invention positioned over an inner door panel configured for a larger sized module;

FIGS. 5B-5C are side views illustrating an exemplary embodiment secured to a vehicle door configured for use with exemplary embodiments of the present invention; and

FIG. 6 illustrates portions of an exemplary embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to a cross arm module for a vehicle. In accordance with an exemplary embodiment of the present invention, a door module for a vehicle door is provided. In one exemplary embodiment, the carrier plate is molded from a material such as plastic or equivalents thereof. In one non-limiting exemplary embodiment and where applicable, the carrier plate and components of the carrier plate are manufactured from an easily molded or formed material such as plastic or equivalents thereof.

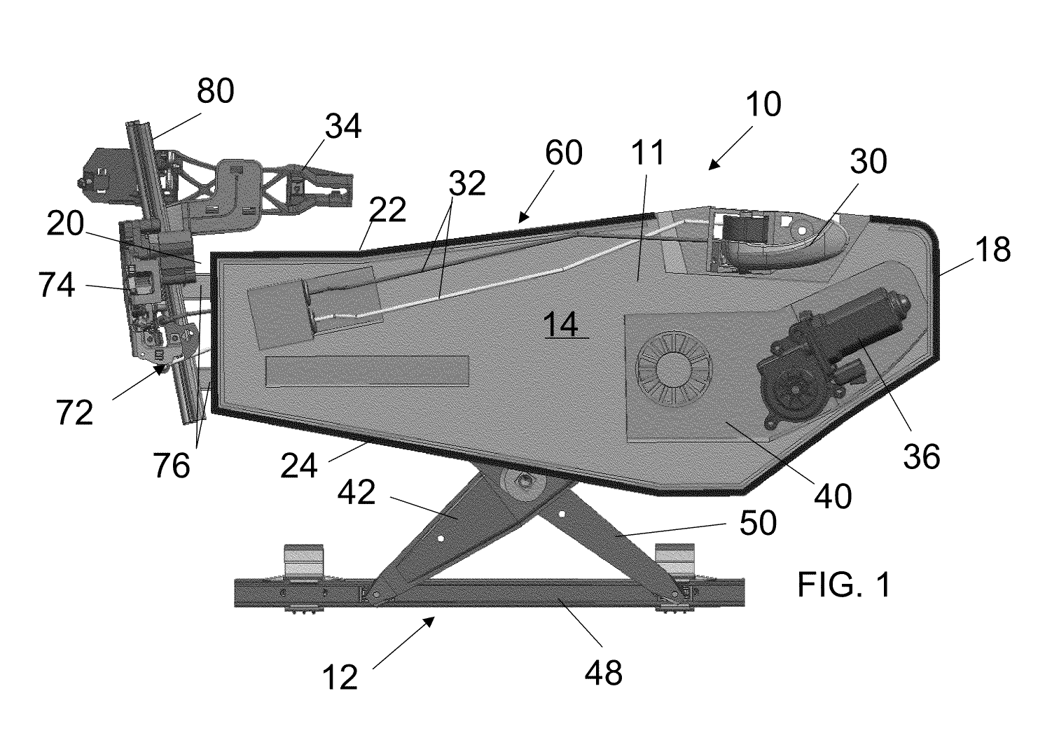

Referring now to FIGS. 1-4, a door module 10 for installation in a vehicle door is illustrated. The door module has a carrier plate 11 configured for use with a cross arm window lift system 12. The carrier plate has an inner surface 14 and an outer surface 16.

In an exemplary embodiment of the present invention the carrier plate of the door module is comprised of a plastic material having a forward end 18, a rearward end 20, an upper or first longitudinal edge 22, and a second or lower longitudinal edge 24. An outer periphery 26 defined by ends 18 and 20 and edges 22 and 24 of the door module is configured to match an opening in a vehicle door such that the door module can be secured to the vehicle door so that at least the window lift system 12 is inserted into the opening in the vehicle door and is received in a cavity of the door and the outer periphery provides a moisture seal about the opening in the vehicle door panel.

The door module is mounted to the vehicle door using mechanical fasteners or any other suitable fastening mechanism or process. In one embodiment, the door module provides additional structure to give structural integrity to the door and various hardware components are attached to the module.

An inside door handle assembly 30 is mounted to the inner surface of the carrier plate. An inside handle actuation assembly 32 of the inside door handle assembly 30 is also shown and extends from the inside handle assembly 30 to the exterior side 16. Inside handle actuation assembly 32 may comprise cables or rods for actuation of a latch when the door handle assembly is manipulated.

An outside handle assembly 34 is mounted onto the carrier plate or panel 11 for positioning on an inner panel 33 of a vehicle door 35 when the vehicle door is assembled.

A motor 36 for driving the window lift system is mounted on the interior side 14 and provides the power to lift and lower the window glass. For example, the motor drives a sector gear 38 rotationally mounted to a housing 40 integrally molded to the carrier plate.

As illustrated, the window lift system 12 is cross arm or X-type powered by the motor 36 and is directly fastened to the panel or carrier plate. The window lift system comprises a lift arm 42 having a first end 44 and an opposing second end 46, wherein the first end is mounted to the sector gear 38 and the second end 46 is slidably mounted to a first channel member 48. The sector gear is driven by a pinion and provides the mechanism by which the window glass is lifted and lowered.

As illustrated, the first channel member is intended to engage the windowpane and is typically mounted to a lower portion of the windowpane. A balancing arm 50 pivotally connects the lift arm 42 at a point that preferably comprises a midpoint of the lift arm. The balancing arm has a first end 52 and an opposing second end 54, wherein the first end is slidably connected to a second channel member 56 mounted onto the outer surface of the carrier plate or panel. The second end of the balancing arm is slidably mounted to the first channel member.

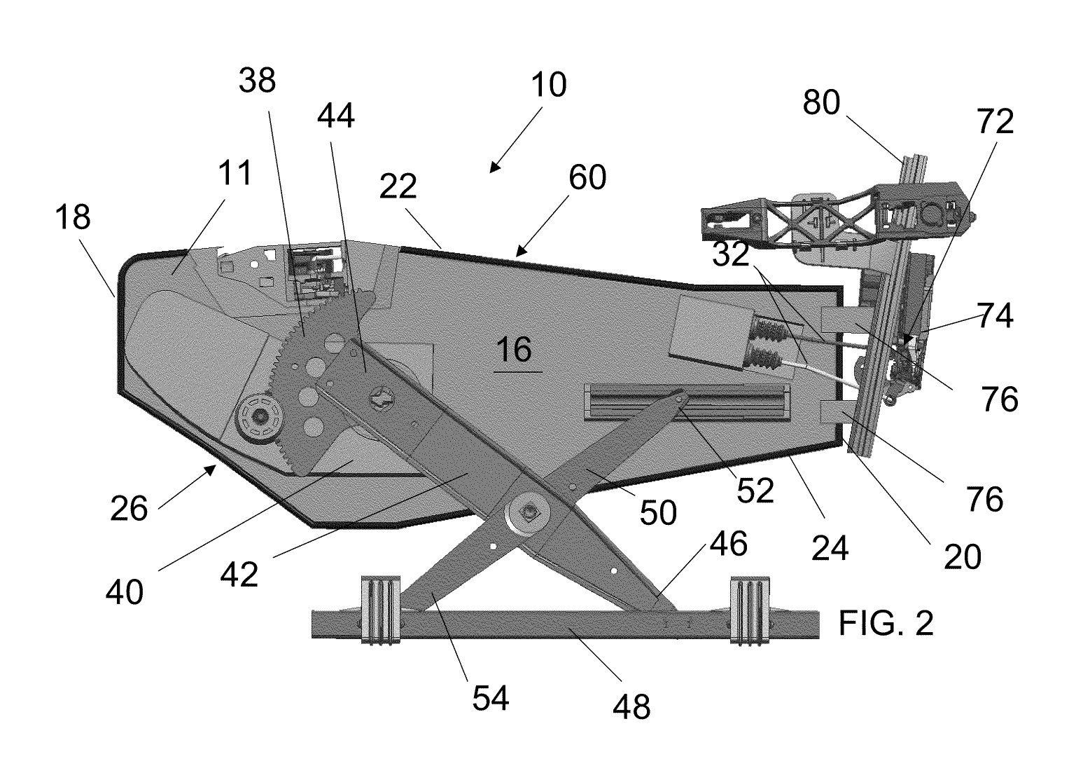

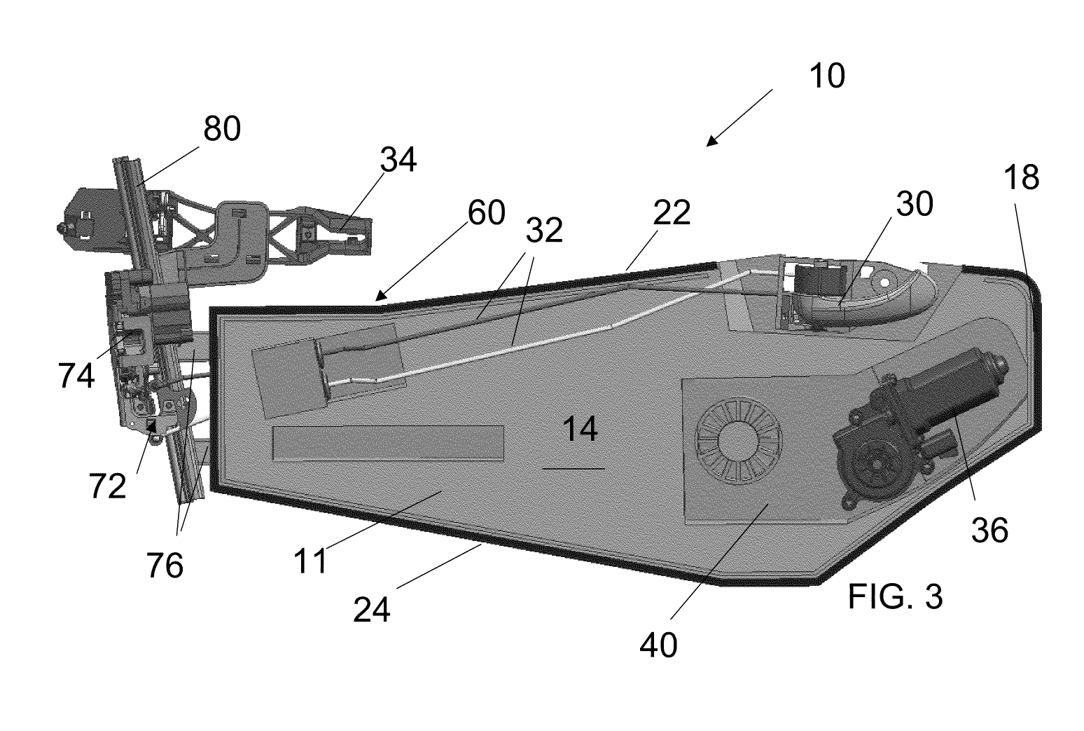

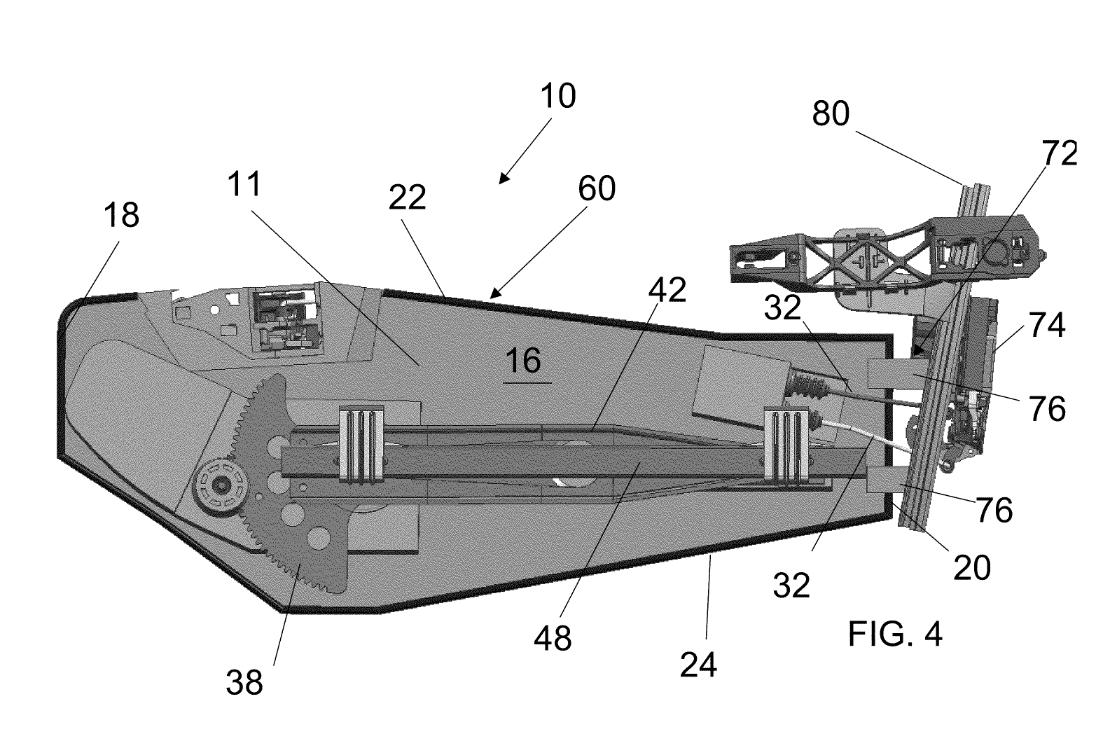

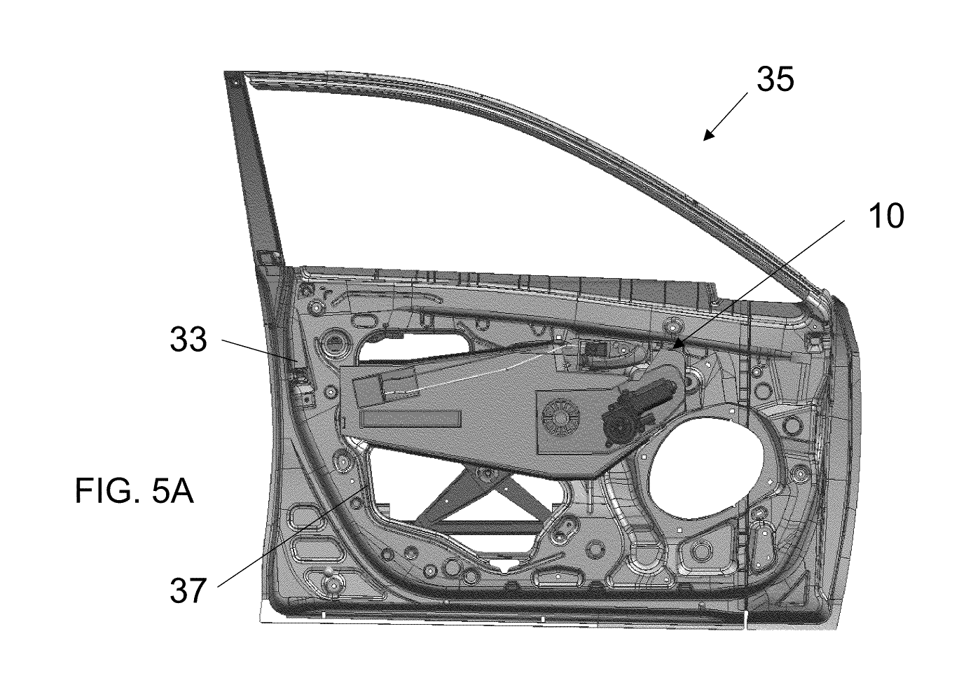

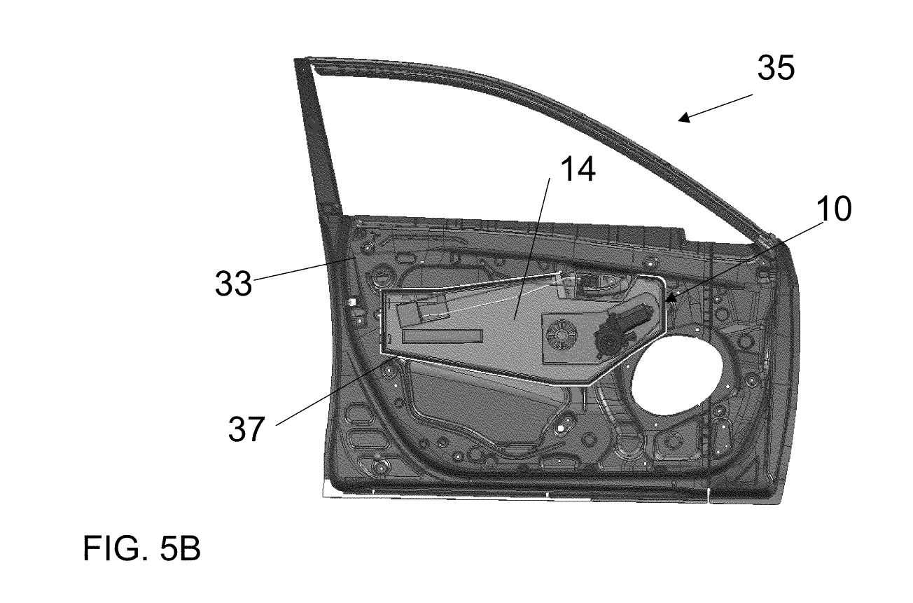

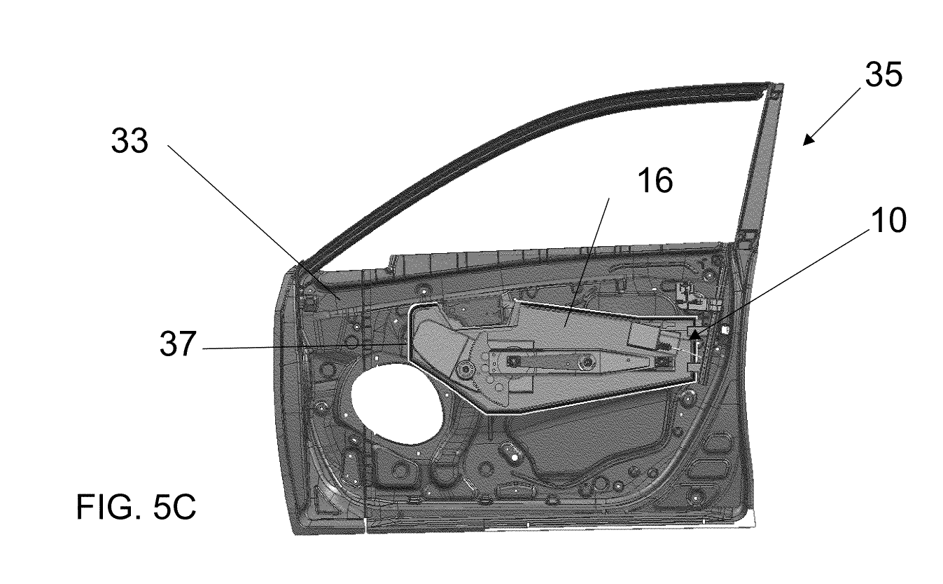

Accordingly and referring now to FIGS. 1-4, the window lift system is illustrated in a full down position (FIGS. 1-2) and a stowed or shipping position (FIGS. 3-4) wherein the lift arm 42, the first channel member 48 and the balancing arm 50 are positioned to be within the periphery of the carrier plate such that when the carrier plate is positioned over an opening in the door (FIGS. 5B-5C), the carrier plate covers the opening. Then the window lift system is capable of being inserted into the opening being covered by the carrier plate since the lift arm 42, the first channel member 48 and the balancing arm 50 are positioned to be within the periphery of the carrier plate. Thereafter, the window lift system can be extended into the full down position wherein the lift arm 42, the first channel member 48 and the balancing arm 50 are positioned outside of the periphery of the carrier plate but inside the vehicle door opening covered by the carrier plate.

FIG. 5A shows the module positioned over a door panel with a large opening 37 to illustrate how much smaller the carrier plate of the cross arm module of an exemplary embodiment of the present invention is compared to other modules as well as showing the cross arm module deployed from it stored position after installation to the inner panel. In accordance with an exemplary embodiment and as illustrated in FIGS. 5B-5C, the periphery of the carrier plate will match the opening 37 in the door panel thus, minimizing the amount of plastic being used on the carrier plate. FIG. 5B is a view showing the inner surface of the door and door module while FIG. 5C is a view showing the outer surface of the door and door module.

Thus, the periphery of the carrier plate and the associated opening in the door can be reduced to the size of the stowed position of the cross arm module and any other components. Therefore, the materials used for the plastic carrier plate are minimized since the opening 37 in the inner door panel only needs to be large enough to be covered by the reduced area of the carrier plate 11 thus reducing the overall cost of manufacturing the carrier plate and the window module. In other words, the cross arm module allows the carrier plate periphery to be smaller and thus opening 37 is smaller, which provides the material cost savings since the plastic required for the carrier plate is reduced.

Referring to FIGS. 1-6, it is also desirable to provide separate “wet” and “dry” areas within the vehicle door to segregate components that do not tolerate water vapor from those that do. For example, electrical controls for power windows and locks (not shown), any wiring harnesses, speakers and inside handle assembly 30 are located on the interior side of the carrier plate thus preventing exposure to water vapor.

In one non-limiting exemplary embodiment, a continuous seal is formed around the periphery of the carrier plate or panel or a substantial portion thereof where the seal interfaces with the inner panel of the door. The seal creates a water vapor barrier that eliminates the need for a separate plastic or foam water barrier.

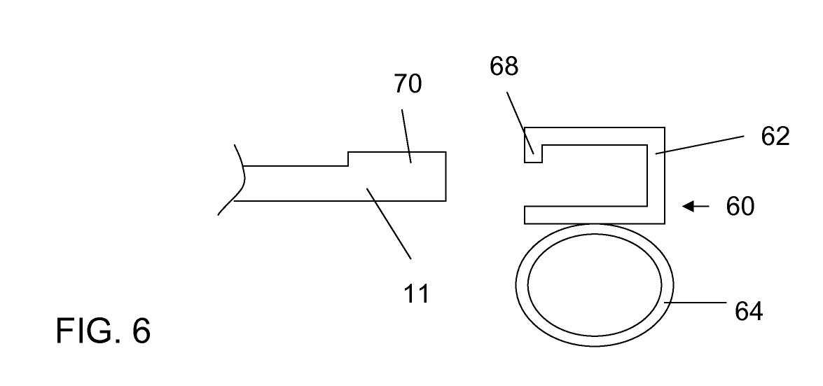

As illustrated in FIGS. 1-6 and in particular FIG. 6, a sealing member 60 is secured along the peripheral portion of the carrier plate. In one non-limiting exemplary embodiment sealing member 60 is co-extruded or formed with any other equivalent process wherein sealing member 60 has two materials each being of a different durometer. For example, a first portion 62 has a stiffer durometer while a second portion 64 has a softer durometer (e.g., the first portion secures the sealing member 60 while the second provides the sealing function). In one embodiment the first portion 62 has a feature 68 for engaging a complimentary feature 70 of the peripheral portion of the carrier plate. This will allow the sealing member 60 to be easily installed to the periphery of the carrier plate by for example a rolling process or a hand applied process. Non-limiting examples of the material contemplated for the first portion would be a polypropylene (PP) and the second portion would be a thermoplastic (TPE) or equivalents thereof.

Accordingly and as illustrated in FIGS. 5B and 5C, the carrier plate 11 with sealing member 60 provides a seal or water barrier as carrier plate 11 is positioned to cover and seal opening 37.

In still another exemplary embodiment and referring to at least FIGS. 1-5C, a latch retainer 72 is integrated into the molded carrier plate, thus saving the separate part cost and the cost of attachment. By integrating the retainer into the molded carrier plate, additional savings are provided by negating the separate part cost and the cost of the attachment of the separate part.

The longitudinal variations are accommodated by a sliding action of a latch 74 onto integrated protrusion(s) 76 of the integral latch retainer 72. Lateral and vertical variation is allowed by deflection of the protrusion(s), wherein the features are robust and engineered to provide the required motion.

The latch is retained by an integral snap fit feature engaging with a receiver in the latch housing. This integration is also achieved without affecting the sealing of the wet/dry carrier by means of a slide action in the molding tool. Moreover, an additional advantage is that the assembly recyclability is also improved with a single material.

Also shown is a rear glass run channel 80 for use with the window lift mechanism.

A method of installing a cross arm door module is also provided, here the door module is positioned into the stowed position illustrated by FIGS. 3 and 4 by energizing motor 36 or manually moving the bottom channel and arms to the position illustrated in FIGS. 3 and 4. Thereafter, the carrier plate is secured to an opening in the vehicle door such that the sealing member is disposed about the periphery of the opening in the door and the widow lift mechanism of the carrier plate is passed through the opening in the door (FIGS. 5B and 5C). Then the widow lift mechanism is capable of being deployed to the full down position wherein components of the window lift system extend past the periphery of the carrier plate.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A cross arm module for a vehicle door, comprising:
a plastic carrier plate configured to have a periphery to completely cover a periphery of an opening in an inner panel of the vehicle door, the plastic carrier plate having an inner surface and an outer surface;
a window lift system mounted to the outer surface, the window lift system having a pair of cross arms each being pivotally secured to each other and movably secured to the outer surface for movement between a first position, wherein the window lift system is capable of being positioned such that no components of the window lift system extend past the periphery of the carrier plate and a second position wherein the window lift system is capable of extending past the periphery of the carrier plate; and
a sealing member disposed about the periphery of the carrier plate, the sealing member providing a moisture barrier between the carrier plate and the opening in the inner panel.

2. The cross arm module as in claim 1, further comprising a motor for driving the window lift system, the motor being mounted to the inner surface of the carrier plate.

3. The cross arm module as in claim 1, wherein the sealing member comprises a first portion and a second portion, the first portion having a harder durometer than the second portion and the first portion is secured to the periphery of the carrier plate and the second portion provides a sealing function between the carrier plate and the vehicle door.

4. The cross arm module as in claim 2, wherein a latch assembly is mounted to a rear end of the carrier plate.

5. The cross arm module as in claim 4, wherein the sealing member comprises a first portion and a second portion, the first portion having a harder durometer than the second portion and the first portion is secured to the periphery of the carrier plate and the second portion provides a sealing function between the carrier plate and the vehicle door.

6. The cross arm module as in claim 1, wherein the pair of cross arms are also movably secured to a channel member that moves within and outside of the periphery of the carrier plate as the cross arms move with respect to each other and the carrier plate.

7. The cross arm module as in claim 6, wherein the sealing member comprises a first portion and a second portion, the first portion having a harder durometer than the second portion and the first portion is secured to the periphery of the carrier plate and the second portion provides a sealing function between the carrier plate and the vehicle door.

8. A method of securing a cross arm module to an inner panel of a vehicle door, the method comprising:
moving a window lift system of the cross arm module to a stowed position such that no components of the window lift system extend past a periphery of a plastic carrier plate of the cross arm module;
securing the plastic carrier plate to an opening in the inner panel, the plastic carrier plate being configured to have a periphery to completely cover a periphery of the opening in the vehicle door, the plastic carrier plate having an inner surface and an outer surface; and
extending the window lift system of the cross arm module to a full down position after the plastic carrier has been secured to the opening in the vehicle door such that components of the window lift system extend past the periphery of the plastic carrier plate of the cross arm module.

9. The method as in claim 8, wherein the cross arm module further comprises a motor for driving the window lift system, the motor being mounted to an inner surface of the carrier plate.

10. The method as in claim 9, wherein a sealing member is disposed about the periphery of the carrier plate.

11. The method as in claim 10, wherein the sealing member comprises a first portion and a second portion, the first portion having a harder durometer than the second portion and the first portion is secured to the periphery of the carrier plate and the second portion provides a sealing function between the carrier plate and the vehicle door.

12. The method as in claim 8, wherein a latch assembly is mounted to a rear end of the carrier plate.

13. The method as in claim 8, wherein the pair of cross arms are also movably secured to a channel member that moves within and outside of the periphery of the carrier plate as the cross arms move with respect to each other and the carrier plate.

14. The method as in claim 13, wherein the sealing member comprises a first portion and a second portion, the first portion having a harder durometer than the second portion and the first portion is secured to the periphery of the carrier plate and the second portion provides a sealing function between the carrier plate and the vehicle door.
